(19) United States
(12) Patent Application Publication
(10) Pub. No.: US 2008/0224859 A1
(43) Pub. Date: Sep. 18, 2008

(54) Door lock control system integrated with sensing and audio/image identification functions

(76) Inventor: Shih-Hsiung Li, Taipei (TW)

Correspondence Address: COOPER & DUNHAM, LLP, 1185 AVENUE OF THE AMERICAS, NEW YORK, NY, 10036, US

(21) Appl. No.: 11/724,573

(22) Filed: Mar. 15, 2007

(51) Int. Cl. G08B 21/00

(52) U.S. Cl. 340/540

(57) ABSTRACT

A door lock control system integrated with sensing and audio/image identification functions includes three identification means. First, an RFID card reader obtains the identification code of a user's RFID card to perform a first identification check. After the first check is passed, the user is asked to make a voice to be compared with a pre-stored voice for a second identification check. After the second check is passed, an image of the user is taken to be compared with a pre-stored image for a third check. After all the three checks are passed, an electronic door lock is opened.

### BACKGROUND OF THE INVENTION

1. Field of the Invention

The invention relates to a door lock without using any key and, in particular to a door lock control system integrated with sensing and audio/image identification (ID) functions.

2. Description of Related Art

The invention of locks provides us with security. However, the use of door locks also restricts human life. Consider the vehicle and housing door locks as an example. Early locks have mechanical structures that are locked and opened using keys. However, they are susceptible from damages, resulting in theft. Also, the user cannot easily open or lock the door without using the appropriate key. This is particularly inconvenient if the user forget to carry or lose the key.

Later on, an electronic lock is invented. The electronic lock is provided with buttons for the user to set a pass code. The user has to enter the correct pass code in order to open the lock. This is convenient because the user does not need to carry a bunch of keys. However, the cost of such an electronic lock is expensive. Therefore, its use is still not popular. Besides, the electronic lock has two types: the ones with a sensor and the one with a remote control. These two types of electronic locks are widely used in entrance control of high-rise buildings. For the door locks with a sensor, the identification check is done between a key card and a sensor on the door lock. The door is unlocked if the check is successful. For the door locks with a remote control, the user uses a remote control to lock/unlock the electronic lock. Although either of these two types of door locks is convenient, both of them are susceptible to ID code duplication and become useless.

The development in vehicle door locks is no different from the usual door locks. Only high-class sedans are equipped with biological ID devices. However, if the car engine is not on and the user encounters a robber, the lock has no prevention or protection mechanism. Therefore, this is still not ideal and should be improved.

### SUMMARY OF THE INVENTION

An objective of the invention is to provide a door lock control system with integrated sensing and audio/image ID functions, so that the user does not need to carry the key and still enjoys a highly reliable identification function.

In accord with the above-mentioned objective, the door lock control system with integrated sensing and audio/image ID functions includes:

an electronic door lock mounted at the door for locking the door;

a central processor built in with an identification checking and controlling program and connected to an electronic control terminal of the electronic door lock for controlling the on and off of the electronic door lock;

an RFID card reader connected to an input terminal of the central processor for reading an ID code of an approaching RFID card and outputting the ID code to the central processor;

a microphone mounted at a position for receiving voice signals inside and outside the door and converting them into an electronic signal;

a voice ID unit connected to the input terminal of the microphone and the input terminal of the central processor for extracting voice features from the electronic signal output from the microphone, determining whether they agree with pre-stored user's voice, and outputting the determination result to the central processor;

an image camera disposed at an appropriate position of the door for taking biological features of the user and outputting the image signal; and

a digital image processor, connected to the output terminal of the image camera via an image processing unit for determining whether the captured images agree with pre-stored user's images.

When using the invention on a normal housing door lock, the RFID card reader first obtains the identification code of a user's RFID card to perform a first identification check. After the first check is passed, the user is asked to make a voice to be compared with a pre-stored voice for a second identification check. After the second check is passed, an image of the user is taken to be compared with a pre-stored image for a third check. After all the three checks are passed, the user is identified as a resident of the community. The electronic door lock is unlocked for the user to enter.

### BRIEF DESCRIPTION OF THE DRAWINGS

FIG. 1 is a block diagram according to a first embodiment of the invention;

FIG. 2 is a flowchart of the identification checking and controlling program according to the first embodiment;

FIG. 3 is a block diagram according to a second embodiment of the invention; and

FIG. 4A-4C is a flowchart of the identification checking and controlling program according to the second embodiment.

### DETAILED DESCRIPTION OF THE PREFERRED EMBODIMENT

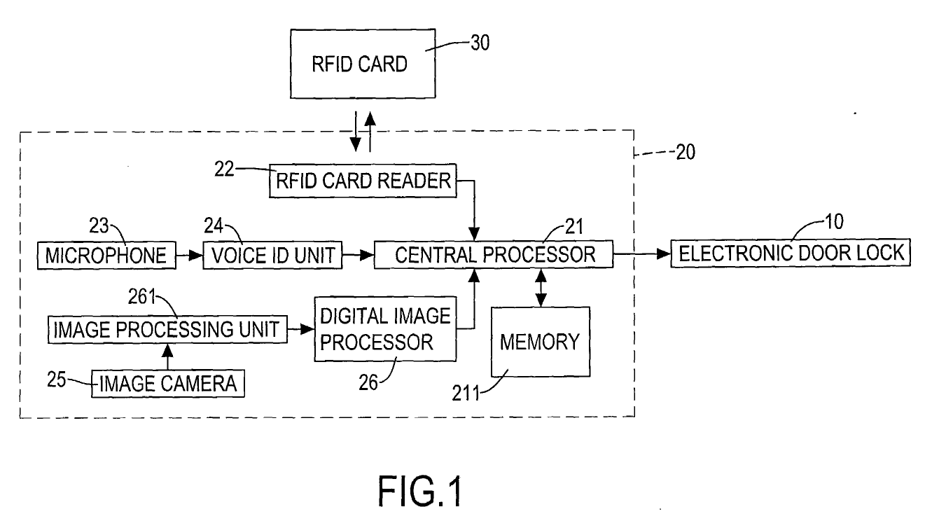

As shown in FIG. 1, a control system 20 of an electronic door lock 10 used in normal housing according to a first embodiment includes a central processor 21, an RFID card reader 22, a microphone 23, a voice ID unit 24, an image camera 25, and a digital image processor 26.

The central processor 21 is connected to an electronic control terminal of the electronic door lock 10 for control the on and off of the electronic door lock 10. The central processor 21 is built in with an ID checking and controlling program. The central processor 21 can be externally connected with a memory 211.

The RFID card reader 22 is connected to an input terminal of the central processor 21. The RFID card reader 22 emits a radio frequency (RF) signal. If an RFID card 30 is approaching, the RFID card reader 22 can read the ID code of the RFID card 30 and outputs the ID code to the central processor 21.

The microphone 23 is mounted at a position for receiving voice signals inside and outside the door and converts them into the corresponding electronic signals for output.

The voice ID unit 24 is connected to an output terminal of the microphone 23 and an input terminal of the central processor 21. The voice ID unit 24 is built in with one or multiple sets of reference voice signals. The voice ID unit 24 extracts voice features from the electronic signal output from the microphone 23 and compares with the reference voice signals to determine whether the electronic signal is the user's voice. The determination result is then output to the central processor 21.

The image camera 25 is mounted at an appropriate position of the door to capture biological features (e.g. the face) of the user for output.

The digital image processor 26 is connected to the output terminal of the image camera 25 via an image processing unit 261. The digital image processor 26 is built in with one multiple reference images for comparing the currently captured image with the reference images. The comparison result is output to the central processor 21.

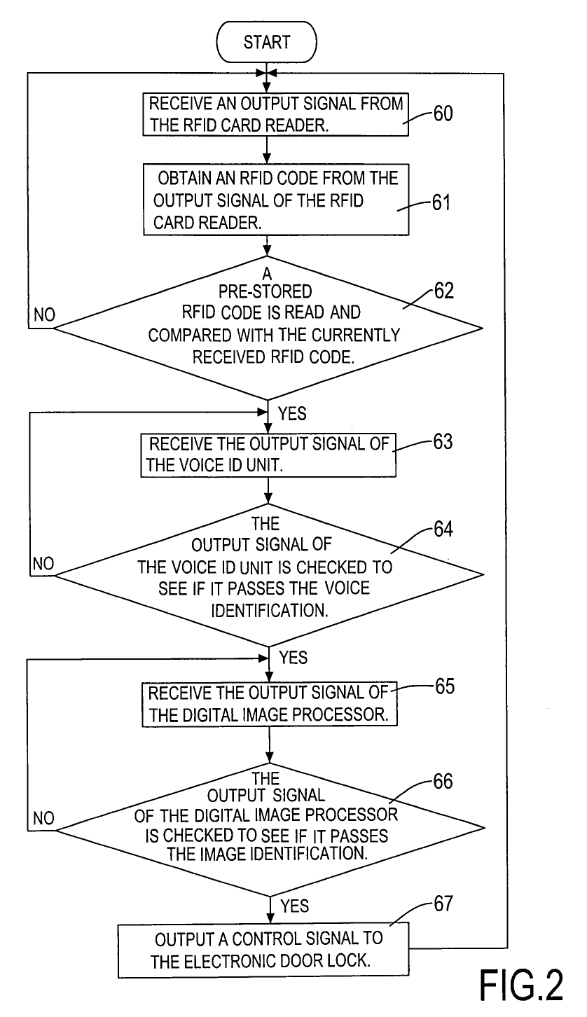

FIG. 2 shows the flowchart of the ID checking and controlling program of the central processor 21. The central processor 21 or its memory 211 is built in with multiple pre-stored RFID codes. The ID checking and controlling program includes the following steps.

In step 60, an output signal from the RFID card reader 22 is received. In step 61, an RFID code is obtained from the output signal of the RFID card reader 22. In step 62, the pre-stored RFID codes are read to compare with the currently received RFID code. If the received RFID code matches one of the multiple RFID codes, the next step 63 follows. Otherwise, the procedure goes to step 60. In step 63, the output signal of the voice ID unit 24 is received. In step 64, the output signal of the voice ID unit 24 is checked to see if it passes the voice identification. If so, the next step 65 follows. Otherwise, the procedure goes back to the previous step 63. In step 65, the output signal of the digital image processor 26 is received. In step 66, the output signal of the digital image processor 26 is checked to see if it passes the image identification. If so, a control signal is output to the electronic door lock 10 in step 67, and step 60 follows. Otherwise, the procedure goes back to the previous step 65.

When using the invention in a normal housing door lock, the RFID card reader 22 first obtains the ID code of a user's RFID card 30 for the first check. Once it passes the check, the invention asks the user to make a voice in order to compare it with a pre-stored voice as the second check. Once it passes the second check, the user image is captured to compare with a pre-stored image as a third check. If all the above-mentioned three checks are passed, the user is identified as one of the residents. The electronic door lock 10 is opened for the user to enter.

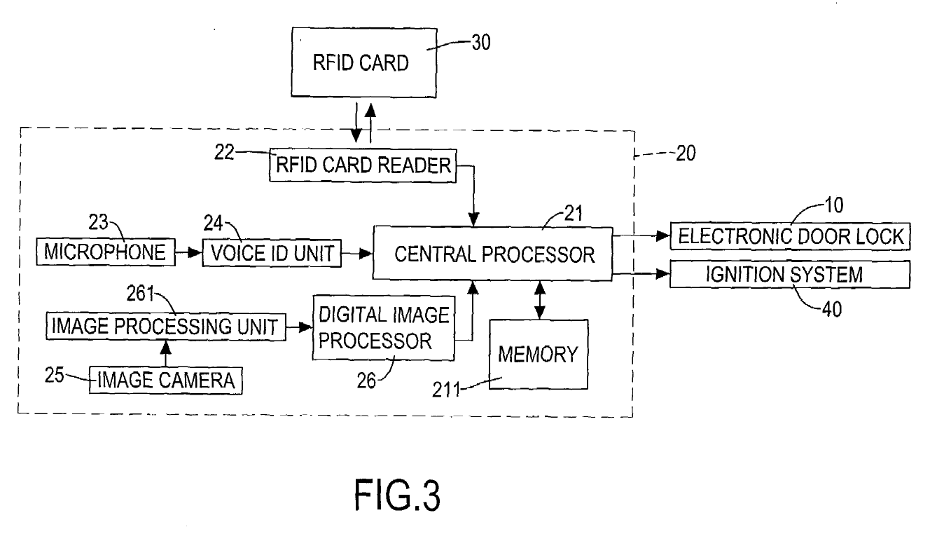

A second embodiment of the disclosed door lock control system 20a is shown in FIG. 3. It is used on a vehicle door lock. Most of its structure is the same as the first embodiment. However, the central processor 21 is further connected with a speaker 29 and a pressure sensor 27 disposed at the driver's seat. The central processor 21 is also connected with an ignition control system 40. Moreover, the image camera 26 is disposed at a position that can capture the driver's face. The image camera 26 captures an image of the user's face to be compared with an image pre-stored in the digital image processor 26. In addition, the voice identification unit 24a is built in with several voice commands (e.g. start the engine). It determines whether the voice received from the microphone 23 contains a voice command. If so, the voice command is output to the central processor 21. The memory 211 stores voice contents of reminders for the driver for the central processor 21 to retrieve and output via the speaker 29.

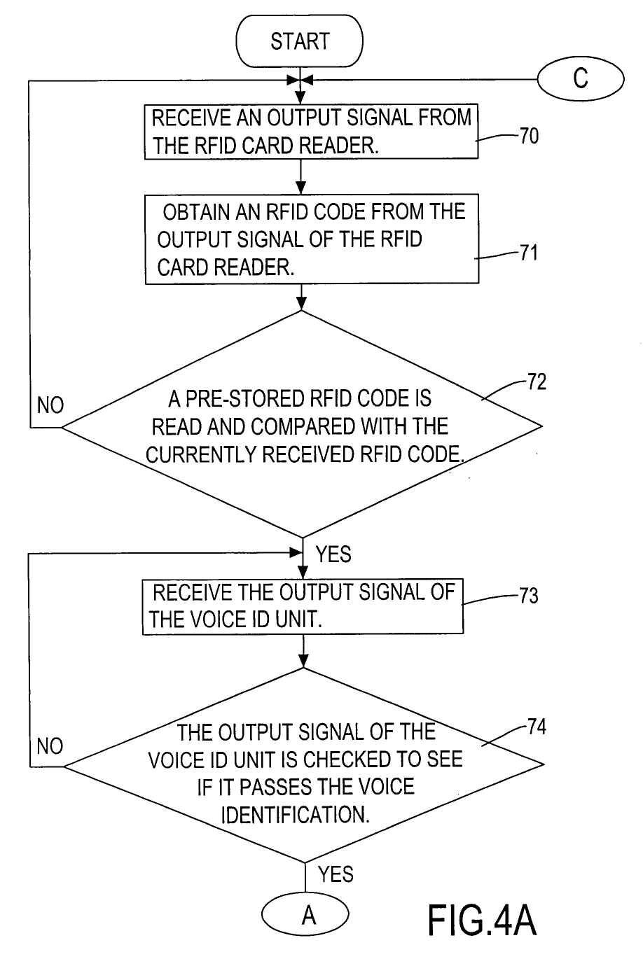

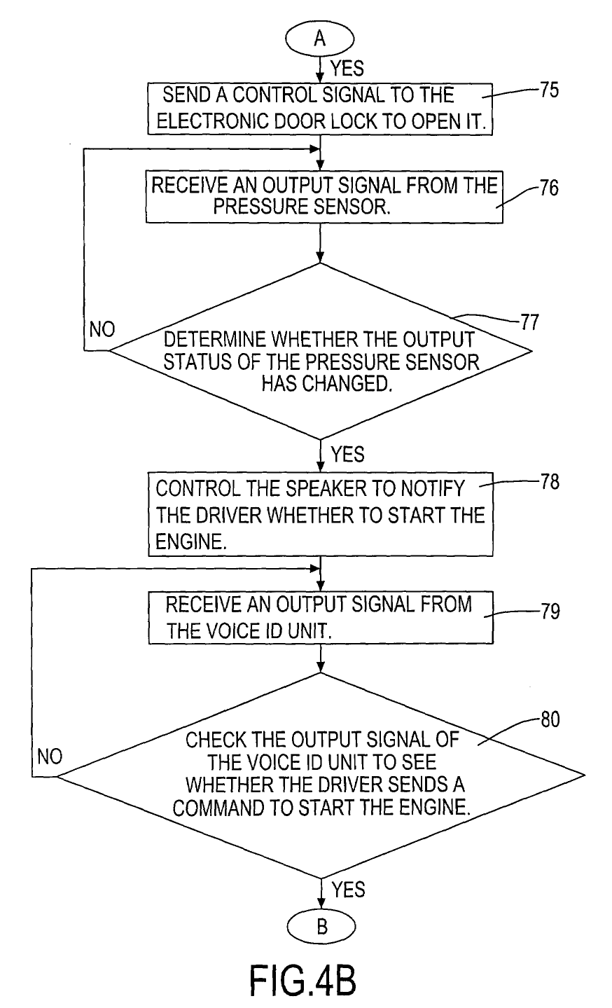

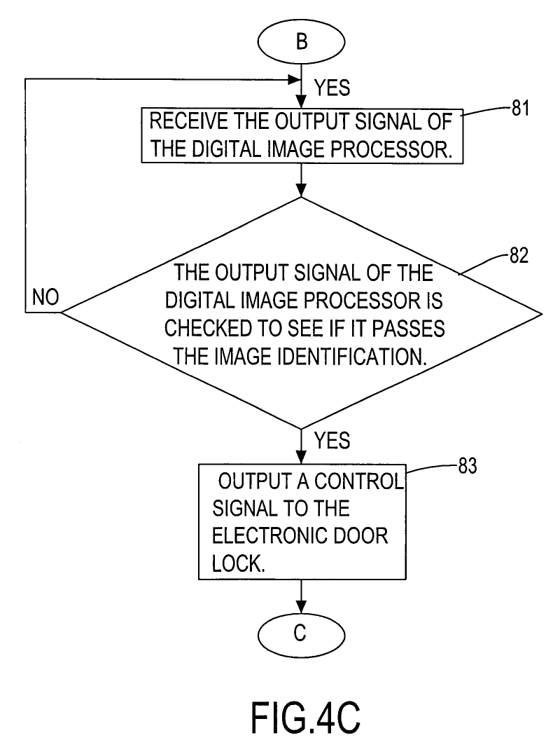

The built-in identification checking and controlling program of the central processor 21 also has a different procedure. As shown in FIG. 4A-4C, the procedure includes the following steps.

In step 70, an output signal of the RFID card reader 22 is received. In step 71, an RFID code is extracted from the output signal of the RFID card reader 22. In step 72, the pre-stored RFID code are read and compared with the currently received RFID code. If any pre-stored RFID code matches the, the next step follows. Otherwise, the procedure goes back to step 70. In step 73, an output signal of the voice ID unit 24a is received. In step 74, the output signal of the voice ID unit 24a is determined whether it successfully passes the voice check. If so, then a control signal is sent to unlock the electronic door lock 10 in step 75. Otherwise, the procedure goes back to the previous step. In steps 76, 77, the whether an output status of the pressure sensor 27 changes is determined. If so, it means the driver has sit on the driver's seat. The speaker in step 78 is controlled to notify the driver whether to start the engine. In step 79, an output signal of the voice ID unit 24a is received. In step 80, the output signal of the voice ID unit 24a is checked to see whether the driver sends a command to start the engine. If so, then the next step follows. Otherwise, the procedure goes back to the previous step. In step 81, an output signal of the digital image processor 26 is received. In step 82, the output signal of the digital image processor 26 is checked to see whether the image check passes. If so, then a control signal is output to the ignition control system 40 for starting the engine in step 83, and the procedure returns to step 70. Otherwise, the procedure goes back to the previous step.

Since most internal devices of vehicles are controlled electronically (e.g. electric windows, stereos, etc), the central processor of this embodiment can be connected with the control terminals of such electronic devices. The voice ID unit is further built in with other voice commands (e.g. turn on A/C, open window, etc). Therefore, the central processor performs controls in response to different voice commands output from the voice ID unit. The driver can then voice control electronic devices inside the vehicle.

Moreover, when the invention is used on a door lock, it can be improved with an anti-robbery function. That is, the above-mentioned voice ID unit is further programmed with a voice command for abnormally starting the engine (e.g. drive the car) that is distinct from the commonly used voice command (e.g. start the engine). The ID checking and controlling program of the central processor 21 further includes an anti-robbery procedure after the step of receiving the output signal of the voice ID unit 24a. It determines whether the output signal thereof is a normal or abnormal voice command. If it is a normal voice command, then the normal steps follow. Otherwise, a control signal is immediately sent to the ignition control system 40 to start the engine right away. At the same time, a timer is started for timing to a predetermined time (e.g. 5-10 minutes). Once the timing is over, the power of the ignition control system 40 is shut down to stop the vehicle's engine. Besides, a distance detector can be disposed in the vehicle. The ignition control system 40 is powered off after the microprocessor determines that the vehicle has moved over a predetermined distance (e.g., 800 m˜1000 m). Therefore, if a driver encounters a robber while opening the car door, he/she only needs to send out the “drive car” command in order to for the driver to conveniently drive the vehicle away. However, in this case, the central processor starts to count the time or measure the distance. Once the predetermined time or distance has been reached, the engine is turned off. The robber cannot restart the engine because it needs to perform the voice check and the robber's voice is different from that of the pre-stored one. Consequently, using the invention on a vehicle door lock can achieve the goal of anti-robbery by combining with the ignition control system. Moreover, this prevents the user from direct conflict with the robber.

What is claimed is:

1. A door lock control system integrated with sensing and audio/image identification (ID) functions, the system comprising:
an electronic door lock mounted at a door for locking the door;
a central processor connected with an electronic control terminal of the electronic door lock for controlling the on and off of the electronic door lock, built in with an ID checking and controlling program, and connected with an memory;
an RFID card reader connected to an input terminal of the central processor for reading an RFID code of an approaching RFID card and outputting the RFID code to the central processor;
a microphone mounted at a position for receiving voices inside and outside the door and converting them into an electronic signal;
a voice ID unit connected to an output terminal of the microphone and an input terminal of the central processor and built in with multiple reference voice signals for extracting voice features in the electronic signal output from the microphone and comparing with the reference voice signals, determining whether the electronic signal matches any one of the referenced voice signals and outputting a determination result to the central processor;
an image camera disposed at an appropriate position of the door for capturing biological features of a user and outputting the captured image; and
a digital image processor connected to an output terminal of the image camera via an image processing unit and built in with multiple reference images for comparing the captured image with the multiple reference images and outputting a determination result to the central processor.

2. The door lock control system as claimed in claim 1, wherein the central processor is pre-stored with a plurality of reference RFID codes and the built-in ID checking and controlling program comprises the steps of:
receiving an output signal from the RFID card reader;
extracting the RFID code from the output signal of the RFID card reader;
reading the reference RFID codes and comparing them with the currently received RFID code of the and continuing to the next step if any reference RFID code matches the received RFID code or returning to the first step if they do not;
receiving an output signal from the voice ID unit;
determining whether the output signal of the voice ID unit passes the voice check and continuing to the next step if it does or returning to the previous step if it does not;
receiving an output signal from the digital image processor; and
determining whether the output signal from the digital image processor passes the image check, and outputting a control signal to the electronic door lock when the image check is passed.

3. The door lock control system as claimed in claim 1 further comprising:
a pressure sensor mounted at a seat of a vehicle and electrically connected with the central processor for detecting whether a driver sits on the seat; and
a speaker mounted inside the vehicle and electrically connected with the central processor.

4. The door lock control system as claimed in claim 1, wherein the central processor is further connected with an ignition control system and the memory stores a voice content of reminding the driver, the voice content being extracted and played via the speaker.

5. The door lock control system as claimed in claim 4, wherein the image camera is disposed inside the vehicle at a position for capturing an image of a driver's face and the digital image processor compares the captured image with pre-stored reference images of driver's face.

6. The door lock control system as claimed in claim 5, wherein the voice ID unit is further built in with a voice command of starting the vehicle engine and determines whether the voice received by the microphone contains the voice command.

7. The door lock control system as claimed in claim 6, wherein the central processor is pre-stored with a plurality of reference RFID codes and the built-in ID checking and controlling program comprises the steps of:
receiving an output signal from the RFID card reader;
extracting an RFID code from the output signal of the RFID card reader;
reading the reference RFID codes and comparing them with the currently received RFID code and continuing to the next step if any reference RFID code agrees the received RFID code or returning to the previous step if they do not;
receiving an output signal from the voice ID unit;
determining whether the output signal of the voice ID unit passes the voice check and continuing to a next step if it does or returning to the previous step if it does not;
determining whether the output state of the pressure sensor is changed and controlling the speaker to remind the driver of whether to start the engine if the output state is changed;
receiving an output signal from the voice ID unit;
determining whether the output signal of the voice ID unit is the command of starting the engine from the driver and executing the next step if it is or going back the previous step if it is not;
receiving an output signal from the digital image processor; and
determining whether the output signal from the digital image processor passes the image check and outputting a control signal to the electronic door lock and returning to the first step if it does or returning to the first step if it does not.

8. The door lock control system as claimed in claim 5, wherein the voice ID unit further stores a voice command of voice controlling electronic devices of the vehicle and sends a signal to the central processor once a voice command is recognized, and the central processor controls the corresponding electronic device according to the voice command output from the voice ID unit.

9. The door lock control system as claimed in claim 6, wherein the voice ID unit further stores a voice command of voice controlling electronic devices of the vehicle and sends a signal to the central processor once a voice command is recognized, and the central processor controls the corresponding electronic device according to the voice command output from the voice ID unit.

10. The door lock control system as claimed in claim 7, wherein the voice ID unit further stores a voice command of voice controlling electronic devices of the vehicle and sends a signal to the central processor once a voice command is recognized, and the central processor controls the corresponding electronic device according to the voice command output from the voice ID unit.

11. The door lock control system as claimed in claim 7, wherein the voice ID unit is pre-stored with a voice command for abnormally starting the engine that is distinct from the commonly used voice command of starting the engine.

12. The door lock control system as claimed in claim 9, wherein the ID checking and controlling program includes an anti-robbery procedure after the step of receiving an output signal from the voice ID unit, the anti-robbery procedure further comprising:
determining whether the output signal from the voice ID unit is a normal or abnormal voice command, and executing the original steps if it is a normal voice command or otherwise immediately outputting a control signal to the ignition control system to immediately start the engine;
starting a timer for timing to a predetermined time;
shutting down the power of the ignition control system for stopping the engine once the predetermined time is reached; and
returning to the first step of the ID checking and controlling program.

13. The door lock control system as claimed in claim 9, wherein the ID checking and controlling program includes an anti-robbery procedure after the step of receiving an output signal from the voice ID unit, the anti-robbery procedure comprising:
determining whether the output signal from the voice ID unit is a normal or abnormal voice command, and executing the original steps if it is a normal voice command or otherwise immediately outputting a control signal to the ignition control system to immediately start the engine;
determining whether the vehicle moves a predetermined distance and shutting down the power of the ignition control system for stopping the engine if it does; and
returning to the first step of the ID checking and controlling program.
